(19) United States
(12) Patent Application Publication
(10) Pub. No.: US 2004/0089113 A1
(43) Pub. Date: May 13, 2004

(54) Wrench

(76) Inventor: Steven P. Morgan, East Point, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/293,839

(22) Filed: Nov. 12, 2002

(51) Int. Cl. B25B 13/00

(52) U.S. Cl. 81/124.3

(57) ABSTRACT

A wrench that enables a mechanic to easily maneuver through the spatial limitations of a general engine compartment and around the constraints of a vacuum pump to access, loosen and/or tighten the nuts that secure the vacuum pump within the engine compartment.

### TECHNICAL FIELD

The present invention relates generally to wrenches, and more specifically in a preferred embodiment to a vacuum-pump wrench. The present invention is particularly suitable for, although not strictly limited to, accessing the nuts and/or bolts of certain aircraft vacuum pumps for the loosening and/or tightening thereof.

### BACKGROUND OF THE INVENTION

Vacuum pumps are ubiquitous in a variety of machinery, including aircraft engine compartments. As with most any machinery and/or engine parts, routine maintenance of a vacuum pump is required for continued proper performance and safe operation thereof. However, the limited area and spatial constraints inherent in many engine compartments can make routine maintenance a difficult task, limiting the mechanic's accessibility to crucial engine parts and/or areas of the vacuum pump.

In view of general engine compartment constraints, removal of vacuum pumps therefrom for maintenance and/or repair thereof typically becomes a tasking and arduous process. In particular, an aviation mechanic's ability to access and loosen the nuts that secure the vacuum pump within the engine compartment is often hindered by the deep and angled recession of the nuts themselves. As such, conventional tools and wrenches become meaningless extensions of a mechanic's reach, as most do little, if anything, in assisting the mechanic to maneuver around and past the bulky body of a standard aircraft vacuum pump.

Therefore, it is readily apparent that there is a need for a vacuum pump wrench that enables a mechanic to easily maneuver through and past general engine compartment/vacuum pump constraints to access, loosen and/or tighten the nuts of an attached vacuum pump. Although a vacuum pump application may have been the inspiration for the preferred embodiment of the present invention, it is contemplated that there are many other suitable applications for the present invention.

### BRIEF SUMMARY OF THE INVENTION

Briefly described, in a preferred embodiment, the present invention overcomes the above-mentioned disadvantages, and meets the recognized need for such a device by providing a vacuum pump wrench that enables a mechanic to easily maneuver through the spatial limitations of a general engine compartment and around the constraints of a vacuum pump to access, loosen and/or tighten the nuts that secure the vacuum pump within the engine compartment.

According to its major aspects and broadly stated, the present invention in its preferred form is a vacuum pump wrench having a first shaft in communication with a second shaft, wherein the second shaft carries a wrench head, and wherein the second shaft has a curved or dipped area designed specifically, in the preferred application, for maneuvering around a vacuum pump to access the nuts that secure the pump within an engine compartment.

More specifically, the present invention, in its preferred use, is a vacuum pump wrench having a preferably straight first shaft portion and a second shaft portion extending therefrom, wherein the second shaft portion is preferably perpendicular to the first shaft portion and carries a wrench head on its end opposite the end proximal to the first shaft portion. The wrench head portion has an aperture formed therethrough for securely receiving and gripping a nut. The end of the first shaft portion, opposite the end attached to the second shaft portion, preferably possesses a drive attachment. The second shaft portion further preferably has a dipped or downwardly bellowed area so as to facilitate use of the wrench on and around a vacuum pump or other obstacle to access difficult to reach nuts and/or bolts.

A feature and advantage of the present invention, in its preferred application, is its ability to allow a mechanic to expeditiously and easily maneuver through the spatial limitations of a general engine compartment and around the constraints of a vacuum pump to access, loosen and/or tighten the nuts and/or bolts that secure the vacuum pump within the engine compartment.

A feature and advantage of the present invention, in its alternate applications, is its ability to allow access to nuts and/or bolts in spatially limited areas.

A feature and advantage of the present invention is its ability to be manufactured to receive, loosen and/or tighten any size nut of a secured vacuum pump.

A feature and advantage of the present invention is its portability.

A feature and advantage of the present invention is its ease of use.

A feature and advantage of the present invention is its simplicity of design.

A feature and advantage of the present invention is its ease of storage.

A feature and advantage of the present invention is its durability.

A feature and advantage of the present invention is its ability to be adapted/altered to allow utilization thereof on most any type of aircraft vacuum pump.

A feature and advantage of the present invention is its ability to be adapted/altered to allow utilization thereof on most any type of vacuum pump.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing,figures, in which like reference numerals denote similar structures and refer to like elements throughout, and in which:

FIG. 1 is a perspective view of a wrench according to a preferred embodiment of present the invention.

FIG. 2 is a side view of a wrench according to a preferred embodiment of present the invention.

FIG. 3 is a rear view of a wrench according to a preferred embodiment of present the invention.

FIG. 4 is a perspective view of a wrench according to an alternate embodiment of present the invention.

### DETAILED DESCRIPTION OF THE PREFERRED AND ALTERNATIVE EMBODIMENTS

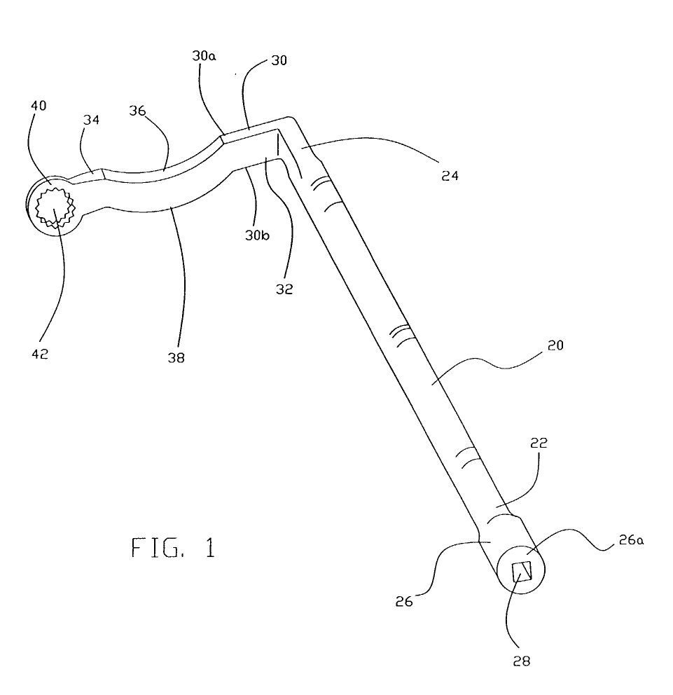

In describing the preferred and alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIGS. 1-3, the present invention in its preferred embodiment and its preferred application is a vacuum pump wrench 10 having a first shaft portion 20, a second shaft portion 30 and a wrench head 40.

Specifically, first shaft portion 20 is preferably elongated and has preferably a generally substantially cylindrical-shaped cross-section, having first end 22 and opposing second end 24. Formed preferably at first end 22 of first shaft portion 20 is drive attachment 26, wherein drive attachment 26 has preferably a cylindrical-shaped outer cross-section and has preferably a slightly greater diameter than the diameter of cylindrical-shaped first shaft portion 20. Drive attachment 26 preferably possesses surface 26a, wherein surface 26a preferably defines a recess 28 preferably dimensioned for receipt of a driving member of a preferably conventional one-fourth inch ratchet and/or extension therein. Although recess 28 is preferably dimensioned to receive the driving member of a one-fourth inch ratchet, drive attachment 26 and recess 28 can be modified accordingly to receive any size ratchet. Moreover, although drive attachment 26 is preferably rigidly formed at end 22 of first shaft portion 20, it is contemplated in an alternate embodiment that drive attachment 26 could be pivotally attached to end 22 via any known pivoting and/or hinging means and locked thereabout so as to further facilitate the overall maneuverability of wrench 10 within constrained areas such as an engine compartment and/or around a vacuum pump when a ratchet is attached thereto.

Although the preferred shape of first shaft portion 20 and drive attachment 26 is cylindrical, other shapes that facilitate utilization of wrench 10 can be used, such as, for exemplary purposes only, oval or square. First shaft portion 20 and drive attachment 26 can further be manufactured to any desired length, so as to permit wrench 10 to access various areas and parts of an engine compartment/vacuum pump found at various depths therein.

Drive attachment 26 and first shaft portion 22 are preferably integrally formed together and are preferably formed from a strong metal such as, for exemplary purposes only, steel, titanium, iron and/or any other suitable metals and/or metal alloys. It is also contemplated that drive attachment 26 could be a handle having a frictional grip for use by hand. It is further contemplated that a leverage arm may extend substantially perpendicular from first shaft portion 20 to further facilitate hand rotation thereof.

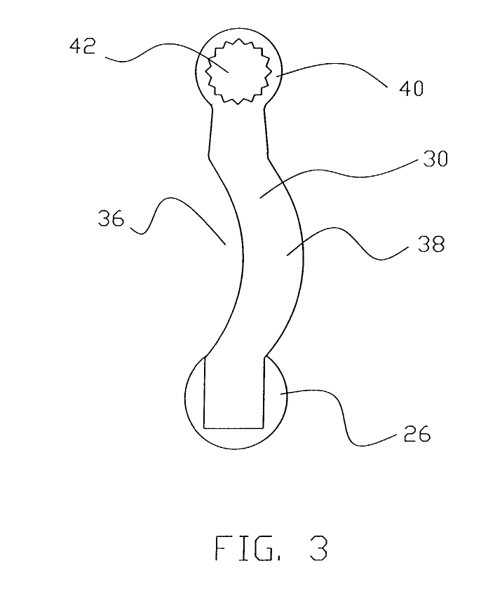

Preferably integrally formed at second end 24 of first shaft portion 20 is second shaft portion 30, wherein second shaft portion 30 is preferably perpendicular to first shaft portion 20. Second shaft portion 30 is preferably generally substantially flattened and preferably has first end 32 and opposing second end 34, wherein first end 32 of second shaft portion 30 is preferably integrally molded with second end 24 of first shaft portion 20. Second shaft portion 30 further preferably has first side 30a and opposing second side 30b, wherein first side 30a preferably has a concave-shaped bellow or cutaway 36, and wherein second side 30b preferably has a reciprocated convex-shaped or outward bend 38. Cutaway 36 and bend 38 are preferably centrally formed and positioned between first end 32 and second end 34 of second shaft portion 30, as is best,illustrated in FIG. 3. The curved nature of cutaway 36 and bend 38, and second shaft portion 30 in general, preferably facilitates the overall maneuverability of wrench 10 within areas having spatial constraints such as, for exemplary purposes only, within an engine compartment and/or around a vacuum pump, thus enabling wrench 10 to access, loosen and/or tighten the nuts that secure the vacuum pump within the engine compartment.

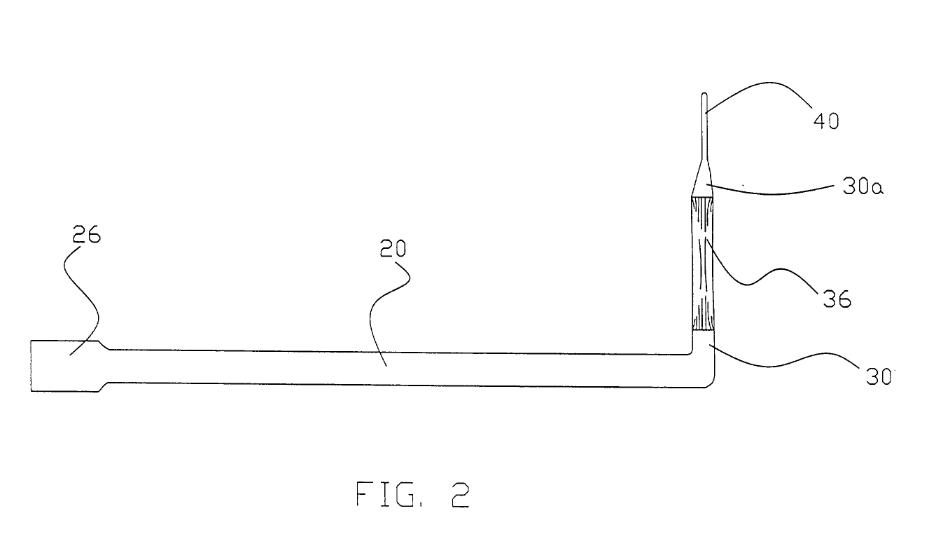

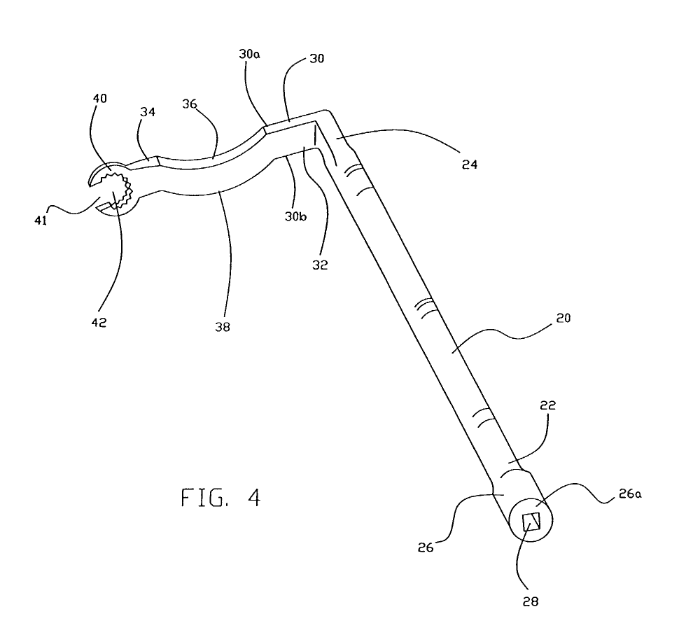

Formed preferably at second end 34 of second shaft portion 30 is preferably generally circular-shaped wrench head 40, wherein wrench head 40 is preferably generally substantially flattened and is of slightly reduced thickness or width as compared to the thickness or width of flattened second shaft portion 30, as is best illustrated in FIG. 2. Wrench head 40 is preferably flattened or thinned so as to ensure greater access to deeply recessed and/or hard-to-reach nuts. Wrench head 40 preferably possesses centrally formed aperture 42, wherein aperture 42 is preferably dimensioned to securely receive a seven-sixteenth inch nut typically utilized to secure the vacuum pump within the engine compartment of an aircraft. Wrench head 40 and second shaft portion 30 are preferably integrally formed together and are preferably formed from a strong metal such as, for exemplary purposes only, steel, titanium, iron and/or any other suitable metals and/or metal alloys. Additionally, preferably first shaft portion 20, drive attachment 26, second shaft portion 30 and wrench head 40 are all integrally formed together, so as to ensure overall durability of wrench 10. Although wrench head 40 is preferably circular-shaped and closed-ended, it is contemplated in an alternate embodiment, that wrench head 40 could possess an open-ended mouth 41, as best illustrated in FIG. 4.

Although aperture 42 is preferably dimensioned to receive a seven-sixteenth inch nut, wrench head 40 and aperture 42 can be modified accordingly to receive any size nut, and could further be modified to possess an internal ratcheting mechanism known within the art. Moreover, although second shaft portion 30 is preferably rigidly formed at second end 24 of first shaft portion 20, and wrench head 40 at second end 34 of second shaft portion 30, it is contemplated in an alternate embodiment that second shaft portion 30 and wrench head 40 could be pivotally attached to their respective ends via any known pivoting and/or hinging means and locked thereabout so as to further facilitate the overall maneuverability of wrench 10 within an area having spatial constraints. Furthermore, although second shaft portion 30 and wrench head 40 are preferably flattened, other shapes that facilitate utilization of wrench 10 for specific applications can be used, such as, for exemplary purposes only, oval. Second shaft portion 30 and wrench head 40 can further be manufactured to any desired length or size, so as to permit wrench 10 to access various areas.

Although wrench 10 is preferably formed as a single molded unit, it is contemplated in an alternate embodiment that first shaft portion 20, drive attachment 26, second shaft portion 30 and wrench head 40 of wrench 10 could all be formed separately and attached together via any known attaching means and/or pivotally and lockably connected together via any known locking and pivoting means.

It is contemplated in yet another embodiment that wrench 10 could be manufactured to any desired length and/or size so as to facilitate utilization of wrench 10 in any feasible application.

It is contemplated in still another alternate embodiment that wrench 10 could possess a second wrench head formed at first end 22 of first shaft portion 20 instead of drive attachment 26.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

What is claimed is:

1. A wrench, comprising:
at least one first shaft portion;
at least one second shaft portion in angled communication with said at least one first shaft portion, said at least one second shaft portion having a curved area; and
at least one wrench head carried by said wrench.

2. The wrench of claim 1 further comprising at least one drive attachment carried by said at least one first shaft portion.

3. The wrench of claim 1, wherein said at least one wrench head is carried by said at least one second shaft portion.

4. The wrench of claim 1, wherein said at least one first shaft portion is perpendicularly attached to said at least one second shaft portion.

5. The wrench of claim 2, wherein said at least one drive attachment is pivotally and lockably attached to said at least one first shaft portion.

6. The wrench of claim 3, wherein said at least one wrench head is pivotally and lockably attached to said at least one second shaft portion.

7. The wrench of claim 1, wherein said at least one first shaft portion is pivotally and lockably attached to said at least one second shaft portion.

8. A wrench, comprising:
at least one first shaft portion;
at least one second shaft portion in angled communication with said at least one first shaft portion, said at least one second shaft portion having a curved area;
at least one wrench head carried by said wrench; and
at least one drive attachment carried by said wrench.

9. The wrench of claim 8, wherein said at least one drive attachment is carried by said at least one first shaft portion.

10. The wrench of claim 8, wherein said at least one wrench head is carried by said at least one second shaft portion.

11. The wrench of claim 8, wherein said at least one first shaft portion is perpendicularly attached to said at least one second shaft portion.

12. The wrench of claim 9, wherein said at least one drive attachment is pivotally and lockably attached to said at least one first shaft portion.

13. The wrench of claim 10, wherein said at least one wrench head is pivotally and lockably attached to said at least one second shaft portion.

14. The wrench of claim 8, wherein said at least one first shaft portion is pivotally and lockably attached to said at least one second shaft portion.

15. A wrench, comprising:
at least one first shaft portion having a first end and a second end;
at least one second shaft portion having a first end and a second end, said first end of said second shaft portion in angled communication with said second end of said at least one first shaft portion, said at least one second shaft portion having a curved area;
at least one wrench head carried by said second end at said at least one second shaft portion; and
at least one drive attachment carried by said first end of said at least one first shaft portion.

16. The wrench of claim 15, wherein said at least one first shaft portion is perpendicularly attached to said at least one second shaft portion.

17. The wrench of claim 15, wherein said at least one drive attachment is pivotally and lockably attached to said at least one first shaft portion.

18. The wrench of claim 15, wherein said at least one wrench head is pivotally and lockably attached to said at least one second shaft portion.

19. The wrench of claim 15, wherein said at least one first shaft portion is pivotally and lockably attached to said at least one second shaft portion.

20. A method of loosening and tightening a bolt, comprising the steps of:
a. obtaining a wrench, comprising:
at least one first shaft portion;
at least one second shaft portion in angled communication with said at least one first shaft portion, said at least one second shaft portion having a curved area; and
at least one wrench head carried by said wrench; and
b. placing said at least one wrench head on the bolt and rotating said wrench in a desired direction.
